(19) United States
(12) Patent Application Publication
(10) Pub. No.: US 2026/0039452 A1
(43) Pub. Date: Feb. 5, 2026

(54) WRAPPED ENCRYPTION

(71) Applicant: nChain Licensing AG, Zug (CH)

(72) Inventor: Jack Owen DAVIES, London (GB)

(21) Appl. No.: 18/998,937

(22) PCT Filed: Jul. 13, 2023
(86) PCT No.: PCT/EP2023/069581

§ 371 Date: Jan. 27, 2025

(30) Foreign Application Priority Data
Aug. 2, 2022 (GB) 2211251.0

(51) Int. Cl. H04L 9/08; H04L 9/00

(52) U.S. Cl. CPC H04L 9/0822; H04L 9/50

(57) ABSTRACT

A computer-implemented method of encrypting data by performing the following steps: a) encrypting the first data item with a first respective encryption key to generate a first encrypted value, b) combining a second data item with the first encrypted value to generate a first combined value, c) encrypting the first combined value with a second respective encryption key to generate a second encrypted value, and d) repeating a process of i) combining a respective next data item with a respective latest encrypted value to generate a respective next combined value, and ii) encrypting the respective next combined value with a respective next encryption key to generate a respective next encrypted value, until a combination of the final data item and a respective latest encrypted value has been encrypted with a respective next encryption key to generate a final encrypted value, the encrypted payload comprising the final encrypted value.

### CROSS REFERENCE TO RELATED APPLICATIONS

This application is the U.S. National Stage of International Application No. PCT/EP2023/069581 filed on Jul. 13, 2023, which claims the benefit of United Kingdom Patent Application No. 2211251.0, filed on Aug. 2, 2022, the contents of which are incorporated herein by reference in their entireties.

### TECHNICAL FIELD

The present disclosure relates to a method of encrypting data.

### BACKGROUND

A blockchain refers to a form of distributed data structure, wherein a duplicate copy of the blockchain is maintained at each of a plurality of nodes in a distributed peer-to-peer (P2P) network (referred to below as a “blockchain network”) and widely publicised. The blockchain comprises a chain of blocks of data, wherein each block comprises one or more transactions. Each transaction, other than so-called “coinbase transactions”, points back to a preceding transaction in a sequence which may span one or more blocks going back to one or more coinbase transactions. Coinbase transactions are discussed further below. Transactions that are submitted to the blockchain network are included in new blocks. New blocks are created by a process often referred to as “mining”, which involves each of a plurality of the nodes competing to perform “proof-of-work”, i.e. solving a cryptographic puzzle based on a representation of a defined set of ordered and validated pending transactions waiting to be included in a new block of the blockchain. It should be noted that the blockchain may be pruned at some nodes, and the publication of blocks can be achieved through the publication of mere block headers.

The transactions in the blockchain may be used for one or more of the following purposes: to convey a digital asset (i.e. a number of digital tokens), to order a set of entries in a virtualised ledger or registry, to receive and process timestamp entries, and/or to time-order index pointers. A blockchain can also be exploited in order to layer additional functionality on top of the blockchain. For example blockchain protocols may allow for storage of additional user data or indexes to data in a transaction. There is no pre-specified limit to the maximum data capacity that can be stored within a single transaction, and therefore increasingly more complex data can be incorporated. For instance this may be used to store an electronic document in the blockchain, or audio or video data.

Nodes of the blockchain network (which are often referred to as “miners”) perform a distributed transaction registration and verification process, which will be described in more detail later. In summary, during this process a node validates transactions and inserts them into a block template for which they attempt to identify a valid proof-of-work solution. Once a valid solution is found, a new block is propagated to other nodes of the network, thus enabling each node to record the new block on the blockchain. In order to have a transaction recorded in the blockchain, a user (e.g. a blockchain client application) sends the transaction to one of the nodes of the network to be propagated. Nodes which receive the transaction may race to find a proof-of-work solution incorporating the validated transaction into a new block. Each node is configured to enforce the same node protocol, which will include one or more conditions for a transaction to be valid. Invalid transactions will not be propagated nor incorporated into blocks. Assuming the transaction is validated and thereby accepted onto the blockchain, then the transaction (including any user data) will thus remain registered and indexed at each of the nodes in the blockchain network as an immutable public record.

The node who successfully solved the proof-of-work puzzle to create the latest block is typically rewarded with a new transaction called the “coinbase transaction” which distributes an amount of the digital asset, i.e. a number of tokens. The detection and rejection of invalid transactions is enforced by the actions of competing nodes who act as agents of the network and are incentivised to report and block malfeasance. The widespread publication of information allows users to continuously audit the performance of nodes. The publication of the mere block headers allows participants to ensure the ongoing integrity of the blockchain.

In an “output-based” model (sometimes referred to as a UTXO-based model), the data structure of a given transaction comprises one or more inputs and one or more outputs. Any spendable output comprises an element specifying an amount of the digital asset that is derivable from the proceeding sequence of transactions. The spendable output is sometimes referred to as a UTXO (“unspent transaction output”). The output may further comprise a locking script specifying a condition for the future redemption of the output. A locking script is a predicate defining the conditions necessary to validate and transfer digital tokens or assets. Each input of a transaction (other than a coinbase transaction) comprises a pointer (i.e. a reference) to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

An alternative type of transaction model is an account-based model. In this case each transaction does not define the amount to be transferred by referring back to the UTXO of a preceding transaction in a sequence of past transactions, but rather by reference to an absolute account balance. The current state of all accounts is stored by the nodes separate to the blockchain and is updated constantly.

A blockchain network is already a type of overlay network overlaid on an underlying network such as the Internet. However, it also possible to overlay a further layer of overlay network on a blockchain. An example of this is known as the Metanet. Each node of the Metanet is a different transaction on a blockchain. Data content and Metanet metadata is stored in a payload of each such transaction, in an output of the transaction by means of an OP_RETURN. The data content is the actual user content which the Metanet is being used to store, e.g. text, images, video or audio content, etc.; whilst the metadata defines links between Metanet nodes. The links or edges between Metanet nodes do not necessarily correspond to spending edges at the blockchain layer. I.e. if the input of a given Metanet transaction points to an output of another, funding transaction at the blockchain layer, the parent of that same transaction or Metanet node at the Metanet layer is not necessarily the same transaction as the funding transaction. Instead the links or edges at the Metanet layer define links between the data content of the Metanet.

### SUMMARY

Various techniques exist for encrypting (i.e. obfuscating) data so as to ensure the privacy and confidentiality of the data. The process of encrypting and decrypting data involves keys: encryption keys for encrypting data, and decryption keys for decrypting data. Depending on the type of encryption scheme (symmetric or asymmetric), the encryption keys may be the same as or different compared to the decryption keys.

Typically a set of data items is encrypted as a whole. That is, the whole set of data items is encrypted, as one, with a single encryption key. A problem with such encryption protocols is that when the data is decrypted, the whole set of data items is revealed. This is problematic if, for example, the dataset contains information of varying importance, sensitivity, classification, etc. Whilst some of the data may be suitable for access by the decrypting party, some of the data may not be. This creates the problem that the decrypting party either gains access to all of the data (by being provided with the decryption key), or gains access to none of the data (in the case that the decryption key is withheld).

Some protocols involve using multiple encryption keys to encrypt the set of data items. That is, a first encryption key is used to encrypt the entire dataset, creating an encrypted dataset, and a second encryption key is used to encrypt the encrypted dataset, offering a further layer of encryption. This process can be repeated several times. This adds an additional layer of security to the data (assuming the encryption keys are different). Using different encryptions schemes to encrypt data items may also add an additional layer of security to the data. However, whilst it may be possible to add additional layers of security to the data using these techniques, the same access problem exists. Namely, it is not possible to prevent an accessing party who is provided with the set of decryption keys from accessing the entire dataset, even if some data items are not suitable for viewing by that party.

It would therefore be desirable to provide an encryption protocol that solves the aforementioned problems by enabling different data items to be selectively revealed. That is, it would be advantage to control the amount of data that is accessible to a decrypting party.

According to one aspect disclosed herein, there is provided a computer-implemented method of encrypting data, wherein the method is performed by an encryption service and comprises: generating an encrypted payload representing a dataset comprising an ordered set of data items starting with a first data item and ending with a final data item, wherein the encrypted payload is generated by performing the following steps: a) encrypting the first data item with a first respective encryption key to generate a first encrypted value, b) combining a second data item with the first encrypted value to generate a first combined value, c) encrypting the first combined value with a second respective encryption key to generate a second encrypted value, and d) repeating a process of i) combining a respective next data item with a respective latest encrypted value to generate a respective next combined value, and ii) encrypting the respective next combined value with a respective next encryption key to generate a respective next encrypted value, until a combination of the final data item and a respective latest encrypted value has been encrypted with a respective next encryption key to generate a final encrypted value, the encrypted payload comprising the final encrypted value.

The disclosed encryption protocol is referred to herein as “wrapped encryption”, which refers to the manner in which a further layer of encryption is wrapped around the first data item as each successive data item is encrypted. That is, a first layer of encryption is applied to (or, wrapped around) the first data item when encrypting the first data item and then a second layer of encryption is applied to (wrapped around) the first data item when encrypting the second data item and the encrypted first data item. At this point, the second data item has only a single layer of encryption, whereas the first data item has two layers of encryption. After the next stage of encryption (in the case that there are three data items in the set), the first data item will have three layers of encryption, the second data item will have two layers of encryption, and the third data item will have a single layer of encryption. This process continues, i.e. another layer of encryption is applied to each data item until all data items have at least one layer of encryption. The first layer of encryption may be referred to as an innermost layer of encryption, and the final layer of encryption may be referred to as an outermost layer of encryption.

This protocol allows different data items to be revealed, during decryption, depending on the number of layers of encryption that can be removed by the provided decryption keys. For example, the encryption service may provide only the decryption key that allows the outermost layer of encryption to be removed, revealing only the final data item. In another example, the encryption service may provide the decryption keys that allow the outermost layer and the penultimate layer of encryption to be removed, revealing both the final data item and the penultimate data item in the dataset. In other examples, the encryption service may provide all decryption keys, allowing all encryption layers to be removed so as to reveal the entire set of data items.

For the purpose of illustration, some embodiments will be described in the context of encrypting data stored as part of the Metanet. However it will be appreciated that this is not limiting and more generally the same principles can be applied to encrypt data stored as part of any overlay network overlaid on a blockchain. Further still, the same principles may be applied to encrypt any type of data, whether the encrypted data be stored on the blockchain or otherwise.

For instance, in some examples the final data item in the dataset includes data relating to a Metanet transaction of a Metanet tree, such as an identifier of the transaction and/or the parent transaction. The data may be structural and/or positional in that the data relates to the structure of the Metanet tree and/or the position of the transaction within the Metanet tree. As an example, the data may identify a link between the transaction and its parent transaction.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain,

FIG. 2 schematically illustrates some examples of transactions which may be recorded in a blockchain,

FIG. 3 is a schematic illustration of a network overlaid on a blockchain;

FIG. 4 is a schematic transaction diagram illustrating an example protocol for overlaying a network such as the Metanet on a blockchain;

FIG. 5 schematically illustrates a hierarchical set of keys having the same tree structure as at least part of a network of Metanet nodes;

FIG. 6 schematically illustrates a scheme for deriving multiple key domains, each comprising a hierarchical set of keys,

FIG. 7 schematically illustrates an example process for encrypting data,

FIG. 8 is a specific example of the process shown in FIG. 7,

FIG. 9 shows an example of splitting of the encryption process between different entities, and

FIG. 10 schematically illustrates an example blockchain transaction storing encrypted data.

### DETAILED DESCRIPTION OF EMBODIMENTS

### 1. Example System Overview

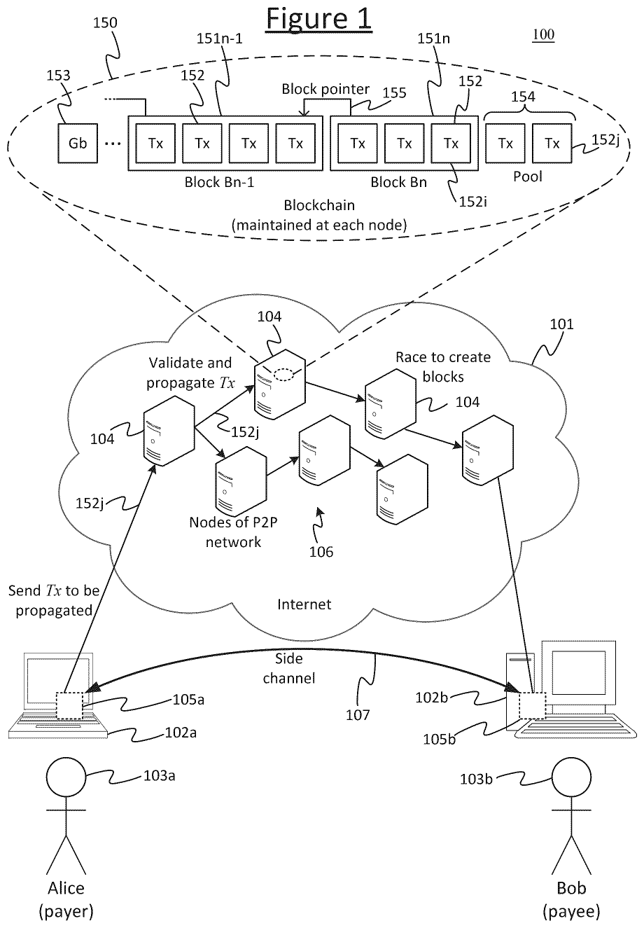

FIG. 1 shows an example system 100 for implementing a blockchain 150. The system 100 may comprise a packet-switched network 101, typically a wide-area internetwork such as the Internet. The packet-switched network 101 comprises a plurality of blockchain nodes 104 that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as application specific integrated circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 106. As mentioned above, maintaining a copy of the blockchain 150 does not necessarily mean storing the blockchain 150 in full. Instead, the blockchain 150 may be pruned of data so long as each blockchain node 150 stores the block header (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout. In one common type of transaction protocol, the data structure of each transaction 152 comprises at least one input and at least one output. Each output specifies an amount representing a quantity of a digital asset as property, an example of which is a user 103 to whom the output is cryptographically locked (requiring a signature or other solution of that user in order to be unlocked and thereby redeemed or spent). Each input points back to the output of a preceding transaction 152, thereby linking the transactions.

Each block 151 also comprises a block pointer 155 pointing back to the previously created block 151 in the chain so as to define a sequential order to the blocks 151. Each transaction 152 (other than a coinbase transaction) comprises a pointer back to a previous transaction so as to define an order to sequences of transactions (N.B. sequences of transactions 152 are allowed to branch). The chain of blocks 151 goes all the way back to a genesis block (Gb) 153 which was the first block in the chain. One or more original transactions 152 early on in the chain 150 pointed to the genesis block 153 rather than a preceding transaction.

Each of the blockchain nodes 104 is configured to forward transactions 152 to other blockchain nodes 104, and thereby cause transactions 152 to be propagated throughout the network 106. Each blockchain node 104 is configured to create blocks 151 and to store a respective copy of the same blockchain 150 in their respective memory. Each blockchain node 104 also maintains an ordered set (or “pool”) 154 of transactions 152 waiting to be incorporated into blocks 151. The ordered pool 154 is often referred to as a “mempool”.

This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. Spending or redeeming does not necessarily imply transfer of a financial asset, though that is certainly one common application. More generally spending could be described as consuming the output, or assigning it to one or more outputs in another, onward transaction. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

The input of the present transaction 152j also comprises the input authorisation, for example the signature of the user 103a to whom the output of the preceding transaction 152i is locked. In turn, the output of the present transaction 152j can be cryptographically locked to a new user or entity 103b. The present transaction 152j can thus transfer the amount defined in the input of the preceding transaction 152i to the new user or entity 103b as defined in the output of the present transaction 152j. In some cases a transaction 152 may have multiple outputs to split the input amount between multiple users or entities (one of whom could be the original user or entity 103a in order to give change). In some cases a transaction can also have multiple inputs to gather together the amounts from multiple outputs of one or more preceding transactions, and redistribute to one or more outputs of the current transaction.

According to an output-based transaction protocol such as bitcoin, when a party 103, such as an individual user or an organization, wishes to enact a new transaction 152j (either manually or by an automated process employed by the party), then the enacting party sends the new transaction from its computer terminal 102 to a recipient. The enacting party or the recipient will eventually send this transaction to one or more of the blockchain nodes 104 of the network 106 (which nowadays are typically servers or data centres, but could in principle be other user terminals). It is also not excluded that the party 103 enacting the new transaction 152j could send the transaction directly to one or more of the blockchain nodes 104 and, in some examples, not to the recipient. A blockchain node 104 that receives a transaction checks whether the transaction is valid according to a blockchain node protocol which is applied at each of the blockchain nodes 104. The blockchain node protocol typically requires the blockchain node 104 to check that a cryptographic signature in the new transaction 152j matches the expected signature, which depends on the previous transaction 152i in an ordered sequence of transactions 152. In such an output-based transaction protocol, this may comprise checking that the cryptographic signature or other authorisation of the party 103 included in the input of the new transaction 152j matches a condition defined in the output of the preceding transaction 152i which the new transaction spends (or “assigns”), wherein this condition typically comprises at least checking that the cryptographic signature or other authorisation in the input of the new transaction 152j unlocks the output of the previous transaction 152i to which the input of the new transaction is linked to. The condition may be at least partially defined by a script included in the output of the preceding transaction 152i. Alternatively it could simply be fixed by the blockchain node protocol alone, or it could be due to a combination of these. Either way, if the new transaction 152j is valid, the blockchain node 104 forwards it to one or more other blockchain nodes 104 in the blockchain network 106. These other blockchain nodes 104 apply the same test according to the same blockchain node protocol, and so forward the new transaction 152j on to one or more further nodes 104, and so forth. In this way the new transaction is propagated throughout the network of blockchain nodes 104.

In an output-based model, the definition of whether a given output (e.g. UTXO) is assigned (or “spent”) is whether it has yet been validly redeemed by the input of another, onward transaction 152j according to the blockchain node protocol. Another condition for a transaction to be valid is that the output of the preceding transaction 152i which it attempts to redeem has not already been redeemed by another transaction. Again if not valid, the transaction 152j will not be propagated (unless flagged as invalid and propagated for alerting) or recorded in the blockchain 150. This guards against double-spending whereby the transactor tries to assign the output of the same transaction more than once. An account-based model on the other hand guards against double-spending by maintaining an account balance. Because again there is a defined order of transactions, the account balance has a single defined state at any one time.

In addition to validating transactions, blockchain nodes 104 also race to be the first to create blocks of transactions in a process commonly referred to as mining, which is supported by “proof-of-work”. At a blockchain node 104, new transactions are added to an ordered pool 154 of valid transactions that have not yet appeared in a block 151 recorded on the blockchain 150. The blockchain nodes then race to assemble a new valid block 151 of transactions 152 from the ordered set of transactions 154 by attempting to solve a cryptographic puzzle. Typically this comprises searching for a “nonce” value such that when the nonce is concatenated with a representation of the ordered pool of pending transactions 154 and hashed, then the output of the hash meets a predetermined condition. E.g. the predetermined condition may be that the output of the hash has a certain predefined number of leading zeros. Note that this is just one particular type of proof-of-work puzzle, and other types are not excluded. A property of a hash function is that it has an unpredictable output with respect to its input. Therefore this search can only be performed by brute force, thus consuming a substantive amount of processing resource at each blockchain node 104 that is trying to solve the puzzle.

The first blockchain node 104 to solve the puzzle announces this to the network 106, providing the solution as proof which can then be easily checked by the other blockchain nodes 104 in the network (once given the solution to a hash it is straightforward to check that it causes the output of the hash to meet the condition). The first blockchain node 104 propagates a block to a threshold consensus of other nodes that accept the block and thus enforce the protocol rules. The ordered set of transactions 154 then becomes recorded as a new block 151 in the blockchain 150 by each of the blockchain nodes 104. A block pointer 155 is also assigned to the new block 151n pointing back to the previously created block 151n-1 in the chain. The significant amount of effort, for example in the form of hash, required to create a proof-of-work solution signals the intent of the first node 104 to follow the rules of the blockchain protocol. Such rules include not accepting a transaction as valid if it spends or assigns the same output as a previously validated transaction, otherwise known as double-spending. Once created, the block 151 cannot be modified since it is recognized and maintained at each of the blockchain nodes 104 in the blockchain network 106. The block pointer 155 also imposes a sequential order to the blocks 151. Since the transactions 152 are recorded in the ordered blocks at each blockchain node 104 in a network 106, this therefore provides an immutable public ledger of the transactions.

Note that different blockchain nodes 104 racing to solve the puzzle at any given time may be doing so based on different snapshots of the pool of yet-to-be published transactions 154 at any given time, depending on when they started searching for a solution or the order in which the transactions were received. Whoever solves their respective puzzle first defines which transactions 152 are included in the next new block 151n and in which order, and the current pool 154 of unpublished transactions is updated. The blockchain nodes 104 then continue to race to create a block from the newly-defined ordered pool of unpublished transactions 154, and so forth. A protocol also exists for resolving any “fork” that may arise, which is where two blockchain nodes 104 solve their puzzle within a very short time of one another such that a conflicting view of the blockchain gets propagated between nodes 104. In short, whichever prong of the fork grows the longest becomes the definitive blockchain 150. Note this should not affect the users or agents of the network as the same transactions will appear in both forks.

According to the bitcoin blockchain (and most other blockchains) a node that successfully constructs a new block 104 is granted the ability to newly assign an additional, accepted amount of the digital asset in a new special kind of transaction which distributes an additional defined quantity of the digital asset (as opposed to an inter-agent, or inter-user transaction which transfers an amount of the digital asset from one agent or user to another). This special type of transaction is usually referred to as a “coinbase transaction”, but may also be termed an “initiation transaction” or “generation transaction”. It typically forms the first transaction of the new block 151n. The proof-of-work signals the intent of the node that constructs the new block to follow the protocol rules allowing this special transaction to be redeemed later. The blockchain protocol rules may require a maturity period, for example 100 blocks, before this special transaction may be redeemed. Often a regular (non-generation) transaction 152 will also specify an additional transaction fee in one of its outputs, to further reward the blockchain node 104 that created the block 151n in which that transaction was published. This fee is normally referred to as the “transaction fee”, and is discussed blow.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Also connected to the network 101 is the computer equipment 102 of each of a plurality of parties 103 in the role of consuming users. These users may interact with the blockchain network 106 but do not participate in validating transactions or constructing blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network 106; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

When a given party 103, say Alice, wishes to send a new transaction 152j to be included in the blockchain 150, then she formulates the new transaction in accordance with the relevant transaction protocol (using the wallet function in her client application 105). She then sends the transaction 152 from the client application 105 to one or more blockchain nodes 104 to which she is connected. E.g. this could be the blockchain node 104 that is best connected to Alice's computer 102. When any given blockchain node 104 receives a new transaction 152j, it handles it in accordance with the blockchain node protocol and its respective role. This comprises first checking whether the newly received transaction 152j meets a certain condition for being “valid”, examples of which will be discussed in more detail shortly. In some transaction protocols, the condition for validation may be configurable on a per-transaction basis by scripts included in the transactions 152. Alternatively the condition could simply be a built-in feature of the node protocol, or be defined by a combination of the script and the node protocol.

On condition that the newly received transaction 152j passes the test for being deemed valid (i.e. on condition that it is “validated”), any blockchain node 104 that receives the transaction 152j will add the new validated transaction 152 to the ordered set of transactions 154 maintained at that blockchain node 104. Further, any blockchain node 104 that receives the transaction 152j will propagate the validated transaction 152 onward to one or more other blockchain nodes 104 in the network 106. Since each blockchain node 104 applies the same protocol, then assuming the transaction 152j is valid, this means it will soon be propagated throughout the whole network 106.

Once admitted to the ordered pool of pending transactions 154 maintained at a given blockchain node 104, that blockchain node 104 will start competing to solve the proof-of-work puzzle on the latest version of their respective pool of 154 including the new transaction 152 (recall that other blockchain nodes 104 may be trying to solve the puzzle based on a different pool of transactions 154, but whoever gets there first will define the set of transactions that are included in the latest block 151. Eventually a blockchain node 104 will solve the puzzle for a part of the ordered pool 154 which includes Alice's transaction 152j). Once the proof-of-work has been done for the pool 154 including the new transaction 152j, it immutably becomes part of one of the blocks 151 in the blockchain 150. Each transaction 152 comprises a pointer back to an earlier transaction, so the order of the transactions is also immutably recorded.

Different blockchain nodes 104 may receive different instances of a given transaction first and therefore have conflicting views of which instance is ‘valid’ before one instance is published in a new block 151, at which point all blockchain nodes 104 agree that the published instance is the only valid instance. If a blockchain node 104 accepts one instance as valid, and then discovers that a second instance has been recorded in the blockchain 150 then that blockchain node 104 must accept this and will discard (i.e. treat as invalid) the instance which it had initially accepted (i.e. the one that has not been published in a block 151).

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

### 2. UTXO-Based Model

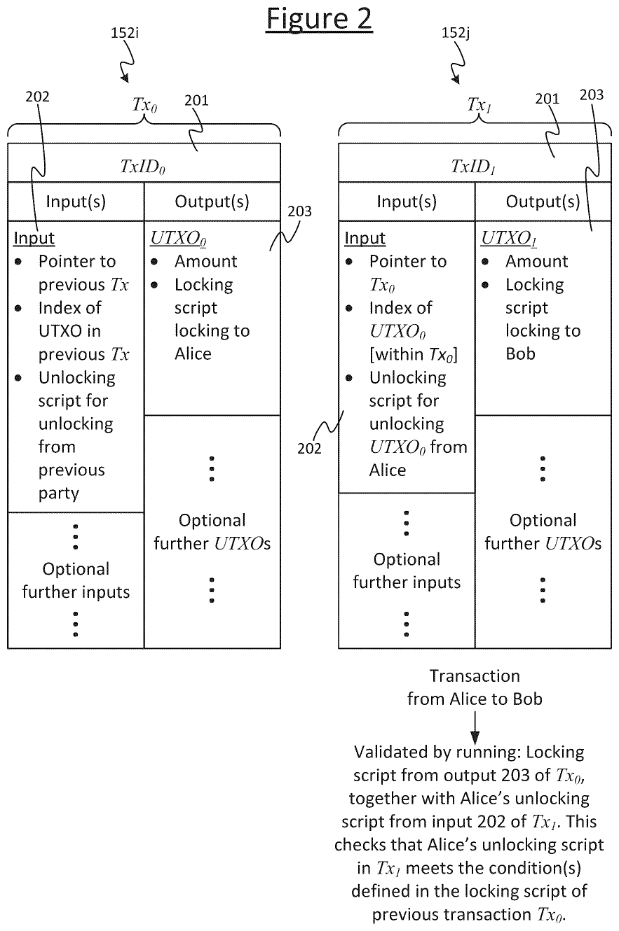

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx_{1”. It takes an amount of the digital asset that is locked to Alice in the output 203 of a preceding transaction 152}i in the sequence, and transfers at least some of this to Bob. The preceding transaction 152i is labelled “Tx₀” in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The preceding transaction Tx₀ may already have been validated and included in a block 151 of the blockchain 150 at the time when Alice creates her new transaction Tx₁, or at least by the time she sends it to the network 106. It may already have been included in one of the blocks 151 at that time, or it may be still waiting in the ordered set 154 in which case it will soon be included in a new block 151. Alternatively Tx₀ and Tx₁ could be created and sent to the network 106 together, or Tx₀ could even be sent after Tx₁ if the node protocol allows for buffering “orphan” transactions. The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed. Typically the locking script locks the amount to a particular party (the beneficiary of the transaction in which it is included). I.e. the locking script defines an unlocking condition, typically comprising a condition that the unlocking script in the input of the subsequent transaction comprises the cryptographic signature of the party to whom the preceding transaction is locked.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Unlocking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains a representation (i.e. a hash) of the public key P_{A} from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx₁ further comprises an unlocking script <Sig P_{A}> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This comprises running the locking script and unlocking script together to check whether the unlocking script meets the condition defined in the locking script (where this condition may comprise one or more criteria). In embodiments this involves concatenating the two scripts:

<Sig P_{A}><P_{A}>∥[Checksig P_{A}]

where “∥” represents a concatenation and “< . . . >” means place the data on the stack, and “[ . . . ]” is a function comprised by the locking script (in this example a stack-based language). Equivalently the scripts may be run one after the other, with a common stack, rather than concatenating the scripts. Either way, when run together, the scripts use the public key P_{A} of Alice, as included in the locking script in the output of Tx₀, to authenticate that the unlocking script in the input of Tx₁ contains the signature of Alice signing the expected portion of data. The expected portion of data itself (the “message”) also needs to be included in order to perform this authentication. In embodiments the signed data comprises the whole of Tx₁ (so a separate element does not need to be included specifying the signed portion of data in the clear, as it is already inherently present).

The details of authentication by public-private cryptography will be familiar to a person skilled in the art. Basically, if Alice has signed a message using her private key, then given Alice's public key and the message in the clear, another entity such as a node 104 is able to authenticate that the message must have been signed by Alice. Signing typically comprises hashing the message, signing the hash, and tagging this onto the message as a signature, thus enabling any holder of the public key to authenticate the signature. Note therefore that any reference herein to signing a particular piece of data or part of a transaction, or such like, can in embodiments mean signing a hash of that piece of data or part of the transaction.

If the unlocking script in Tx₁ meets the one or more conditions specified in the locking script of Tx₀ (so in the example shown, if Alice's signature is provided in Tx₁ and authenticated), then the blockchain node 104 deems Tx₁ valid. This means that the blockchain node 104 will add Tx₁ to the ordered pool of pending transactions 154. The blockchain node 104 will also forward the transaction Tx₁ to one or more other blockchain nodes 104 in the network 106, so that it will be propagated throughout the network 106. Once Tx₁ has been validated and included in the blockchain 150, this defines UTXO₀ from Tx₀ as spent. Note that Tx₁ can only be valid if it spends an unspent transaction output 203. If it attempts to spend an output that has already been spent by another transaction 152, then Tx₁ will be invalid even if all the other conditions are met. Hence the blockchain node 104 also needs to check whether the referenced UTXO in the preceding transaction Tx₀ is already spent (i.e. whether it has already formed a valid input to another valid transaction). This is one reason why it is important for the blockchain 150 to impose a defined order on the transactions 152. In practice a given blockchain node 104 may maintain a separate database marking which UTXOs 203 in which transactions 152 have been spent, but ultimately what defines whether a UTXO has been spent is whether it has already formed a valid input to another valid transaction in the blockchain 150.

If the total amount specified in all the outputs 203 of a given transaction 152 is greater than the total amount pointed to by all its inputs 202, this is another basis for invalidity in most transaction models. Therefore such transactions will not be propagated nor included in a block 151.

Note that in UTXO-based transaction models, a given UTXO needs to be spent as a whole. It cannot “leave behind” a fraction of the amount defined in the UTXO as spent while another fraction is spent. However the amount from the UTXO can be split between multiple outputs of the next transaction. E.g. the amount defined in UTXO₀ in Tx₀ can be split between multiple UTXOs in Tx₁. Hence if Alice does not want to give Bob all of the amount defined in UTXO₀, she can use the remainder to give herself change in a second output of Tx₁, or pay another party.

In practice Alice will also usually need to include a fee for the bitcoin node 104 that successfully includes her transaction 104 in a block 151. If Alice does not include such a fee, Tx₀ may be rejected by the blockchain nodes 104, and hence although technically valid, may not be propagated and included in the blockchain 150 (the node protocol does not force blockchain nodes 104 to accept transactions 152 if they don't want). In some protocols, the transaction fee does not require its own separate output 203 (i.e. does not need a separate UTXO). Instead any difference between the total amount pointed to by the input(s) 202 and the total amount of specified in the output(s) 203 of a given transaction 152 is automatically given to the blockchain node 104 publishing the transaction. E.g. say a pointer to UTXO₀ is the only input to Tx₁, and Tx₁ has only one output UTXO₁. If the amount of the digital asset specified in UTXO₀ is greater than the amount specified in UTXO₁, then the difference may be assigned (or spent) by the node 104 that wins the proof-of-work race to create the block containing UTXO₁. Alternatively or additionally however, it is not necessarily excluded that a transaction fee could be specified explicitly in its own one of the UTXOs 203 of the transaction 152.

Alice and Bob's digital assets consist of the UTXOs locked to them in any transactions 152 anywhere in the blockchain 150. Hence typically, the assets of a given party 103 are scattered throughout the UTXOs of various transactions 152 throughout the blockchain 150. There is no one number stored anywhere in the blockchain 150 that defines the total balance of a given party 103. It is the role of the wallet function in the client application 105 to collate together the values of all the various UTXOs which are locked to the respective party and have not yet been spent in another onward transaction. It can do this by querying the copy of the blockchain 150 as stored at any of the bitcoin nodes 104.

Note that the script code is often represented schematically (i.e. not using the exact language). For example, one may use operation codes (opcodes) to represent a particular function. “OP_ . . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain.

Typically an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

### 3. Side Channel

As shown in FIG. 1, the client application on each of Alice and Bob's computer equipment 102a, 120b, respectively, may comprise additional communication functionality. This additional functionality enables Alice 103a to establish a separate side channel 107 with Bob 103b (at the instigation of either party or a third party). The side channel 107 enables exchange of data separately from the blockchain network. Such communication is sometimes referred to as “off-chain” communication. For instance this may be used to exchange a transaction 152 between Alice and Bob without the transaction (yet) being registered onto the blockchain network 106 or making its way onto the chain 150, until one of the parties chooses to broadcast it to the network 106. Sharing a transaction in this way is sometimes referred to as sharing a “transaction template”. A transaction template may lack one or more inputs and/or outputs that are required in order to form a complete transaction. Alternatively or additionally, the side channel 107 may be used to exchange any other transaction related data, such as keys, negotiated amounts or terms, data content, etc.

The side channel 107 may be established via the same packet-switched network 101 as the blockchain network 106. Alternatively or additionally, the side channel 301 may be established via a different network such as a mobile cellular network, or a local area network such as a local wireless network, or even a direct wired or wireless link between Alice and Bob's devices 102a, 102b. Generally, the side channel 107 as referred to anywhere herein may comprise any one or more links via one or more networking technologies or communication media for exchanging data “off-chain”, i.e. separately from the blockchain network 106. Where more than one link is used, then the bundle or collection of off-chain links as a whole may be referred to as the side channel 107. Note therefore that if it is said that Alice and Bob exchange certain pieces of information or data, or such like, over the side channel 107, then this does not necessarily imply all these pieces of data have to be send over exactly the same link or even the same type of network.

### 4. Layer-2 Overlay Network

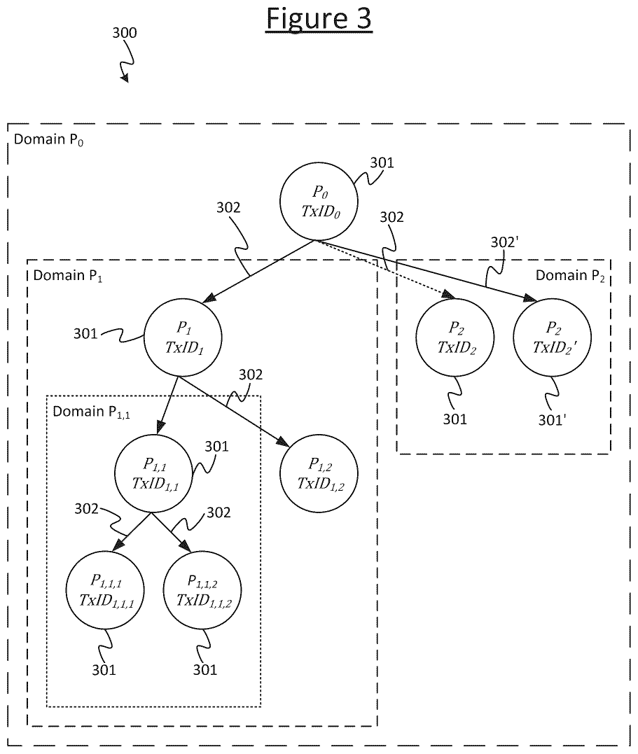

A blockchain network 106 is already a form of overlay network overlaid on a network such as the Internet 101. However, it is also possible to layer another layer of overlay network on top of a blockchain. This is illustrated by way of example in FIG. 3. An example is the Metanet. Such a network could also be referred to as a “layer-2” network, in the sense that it is a second layer of overlay network relative to a base network 101 (e.g. Internet) as the underlying network infrastructure and the blockchain network 106 as the first layer of overlay network overlaid on the base network.

This second tier of overlay network 300 comprises a network of nodes 301 and edges 302. Note that a node 301 now refers to a node at the layer of the Metanet (or other such network overlaid on the blockchain), not a node 104 at the layer of the blockchain network 106 as discussed previously in relation to FIGS. 1 and 2. Each node 301 of the Metanet network (or the like) is a different respective transaction 152 on the blockchain 150, each of which stores data in a payload of the respective transaction. Hence a node 301 of the Metanet network 300 (or the like) may also be referred to herein as a data-storage node or data-storage transaction. The data stored therein may comprise data content and/or metadata, typically both. In an output-based model it may be stored in an output 203 of the respective transaction. The output may be spendable or unspendable. The output may be made unspendable by means of one or more opcodes in the locking script that terminates the script when run. E.g. in a system that employs the Script language, this may be the combination of the OP_0 and OP_RETURN opcodes. However this is not limited and the person skilled in the art will be aware of other techniques for storing any arbitrary payload data in a transaction in other blockchain systems, e.g. in a system employing an account-based model. The following may be exemplified in terms of an output-based model, but this is not limiting.

Note that the layer-2 overlay network 300 may consist purely of data, being entirely virtual. I.e. the nodes 301 and edges 302 of the Metanet or such like, as an overlay network overlaid on the transactions 152 of the blockchain 150, do not necessarily correspond to any particular physical actors or entities of the underlying blockchain network 106 or underlying network infrastructure 101.

The data content is the actual data the Metanet (or the like) is being used to store, e.g. text, audio, still or moving images, or other files or documents. It may also be referred to as user content or user data. The metadata implements the protocol for layering the network on top of the blockchain 150. In at least some of the transactions 152 it defines links between the data content. These may also be described as edges 302 between the nodes 301. The link or pointer may for example comprise the transaction ID, TxIDparent, of the parent node. Note that a “link” as referred to herein does not necessarily imply a hypertext link, though that is one possibility. More generally a link could refer to any form of pointer pointing to another node 301 to which the current node 301 is related at the Metatnet layer (or other such overlay layer layered on top of the blockchain 150).

For convenience the following will be described by way of example in terms of the Metanet, but it will be appreciated that this is not limiting and more generally, anywhere herein where reference is made to the Metanet, this may be replaced with any overlay network overlaid on a blockchain. Similarly any reference to a Metanet node may be replaced with reference to any overlay network node, or data-storage node of the overlay network, and any reference to a Metanet link or edge may be replaced with reference to any overlay network edge or link at the layer of the overlay network in question.

The Metanet protocol defines a scheme and standard for structuring on-chain data that can be recorded on a public blockchain and used in various applications for many use cases. The protocol specifies that graph structures, comprising nodes and edges, can be constructed from sets of blockchain transactions, and that these structures may be used to store, convey, represent and distribute data (‘content’) of any nature. By treating transactions as nodes, and signatures as edges created between transactions, the Metanet protocol allows for the creation of on-chain graph structures as shown in FIG. 3.

As can be seen, the nodes 301 and edges 302 of the Metanet 300 form a tree structure. I.e. a parent node 301 is linked to one or more child nodes 301, and any given child 301 may itself be a parent linked to one or more children of its own, and so forth. Note that the tree structure in question for the present purposes may only be a subset of a wider tree or graph.

FIG. 3 also illustrates how a node 301 and its associated edge 302 may be updated. Since transactions are recorded immutably on the blockchain 152, an update to a Metanet node 301 requires creating a new instance 301′ and corresponding edge 302′ by means of a new transaction 152.

The structure of FIG. 3 may comprise nested domains, e.g. the structure of a website and its pages, where a ‘top level domain’ encapsulates the sub domains below it, and so on. One functional key domain (to be discussed later, e.g. the domain of the writing keys, funding keys or encryption keys) can span many of these structure domains. The structural “domains” shown in FIG. 3 should not be confused with the functional key domains discussed later.

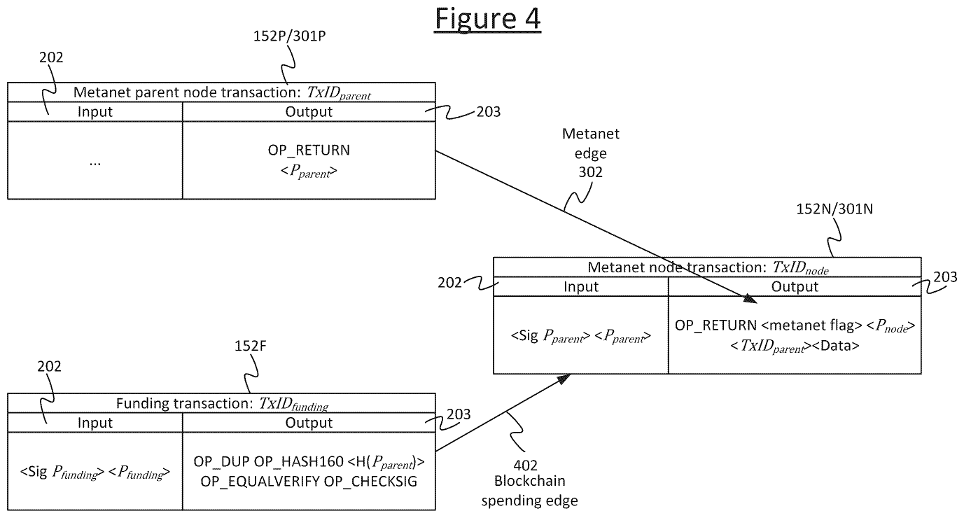

The circles in FIG. 3 represent nodes, which are simply transactions that are created according to the rule set of Metanet protocol. An example of a transaction 152N that is created and formatted according that rule set is shown in FIG. 4.

The transaction 152N on the right-hand side of FIG. 4 represents a transaction 152 of the blockchain 150 implementing a given node 301N (a child) of the Metanet. The transaction 152P in the top-left of FIG. 4 represents a transaction of the blockchain 150 which implements a parent of the child node 152N at the Metanet layer. The child node transaction 152N has an input 202 which comprises an unlocking script, and which points to the output 203 of a funding transaction 152F of the blockchain 150. In other words the output of the funding transaction 152F is consumed by the input of the Metanet node 152N. Note that the funding transaction 152F and the Metanet parent transaction 152P are not necessarily the same transaction (though that is not excluded either).

The child transaction 152N includes an unspendable output 203, e.g. made unspendable by an OP_RETURN, which holds a payload (a payload from the perspective of the blockchain layer). This payload may comprise data content of the Metanet, which may or may not be encrypted. In FIG. 4, by way of example, the data content (“Data”) is shown in the clear. However, as discussed further below, this could be replaced by an encrypted version of the data, (in which case <Data> would be replaced by <e (Data)> in FIG. 4, where “e” represents that the data is encrypted).

The payload of the child transaction 152N also comprises metadata of the Metanet network layer. This metadata comprises at least the transaction identifier of the parent transaction 152P. This creates a link (edge) 302 at the Metanet layer. It may also be required by the Metanet protocol to include a key Pnode associated with the child node 301N.

The locking script of the output 203 of the funding transaction 152F also requires a signature to be included in the unlocking script in the input 202 of the child node 152N. Specifically, this signature is required to be a signature signed using a key Pparent associated with the Metanet parent (i.e. a message signed by that key). This creates an edge 402 (sometimes called a spending edge) at the blockchain layer. If the required signature is not included in the unlocking script in the input 202 of the child transaction 152N, then the child transaction 152N will not be validated by the nodes 104 of the blockchain network 106, and hence will not be propagated through the blockchain network 106 nor recorded on the blockchain 150. Note again however that the funding transaction 152F is not necessarily the same blockchain transaction 152 as the Metanet parent transaction 152P, and hence the blockchain layer spending edge 402 is not necessarily the same as the Metanet layer edge 302.

FIG. 4 outlines only certain relevant components of a Metanet transaction as an abstraction of the transaction in its entirety. These components, in addition to a protocol identifier flag, include:
A public key P_node;
A signature SigP_Parent of a parent public key P_Parent;
The transaction ID TxID_node of the node itself; and
The transaction ID TxID_Parent of the parent of the node.

The placeholder <Data> refers generally to any content data that may be included in the Metanet node transaction. It is also likely in many applications that one would want to encrypt the data. Encryption of data is discussed further below.

Each Metanet node 301 can be uniquely identified by the pair (P_node, TxID_node), which is an index that allows for powerful versioning and permissioning control to be inherited by Metanet graphs. It should also be appreciated that each Metanet node contains enough information to identify itself (P_node, TxID_node) and its parent (P_parent, TxID_parent).

In order to ensure that a Metanet node 301N transaction contains the correct input signature SigP_Parent from a parent node 301P, it may be desirable in many cases to create funding transactions to facilitate this, which is shown in the bottom-left of FIG. 4.

The parent key Pparent and/or child node key Pnode can be seen as a writing key that authorises writing the data of the child node 301N to the blockchain 150. These may also be referred to herein as “structure keys”.

### 5. Hierarchical Key Sets

The keys associated with blockchain transactions 152, pertaining to a particular user or application, are typically managed using a hierarchical key structure. For instance, a common standard, known as hierarchical deterministic (HD) key management, has emerged for handling the many private and public keys that may be associated with a given user's wallet. The standard is designed to facilitate the handling of many such key-pairs by: ensuring that all keys in a user's wallet can be derived from a single source of entropy; and ensuring that keys are derived in a deterministic manner from that seed, using publicly-known derivation functions. HD wallets in themselves are well-known, and are simply wallets which use the well-defined standards for deriving keys to be used in transactions outlined in multiple improvement proposals known as “BIPs”, namely BIP32, BIP39 and BIP44. In essence, these standards define ways to: deterministically generate many private and public keys from a ‘seed’ key; define ‘paths’ for generating a particular descendent key from a seed key; and define hierarchical wallet structures using the deterministic key derivation functions. These standards for handling keys associated with a given user's funds, or with the transactions of a particular application, are widely used in the blockchain industry.

A deterministic algorithm for deriving one key from another key in a deterministic manner is sometimes referred to as a child key derivation (CKD) function. Thus a set of keys can be determined, starting from a seed, which are all related to one another in a hierarchical manner. Such a hierarchal set of keys also has a tree structure. That is, the keys within the set are derived from one another in a hierarchy of derivation which follows a tree structure. I.e. one or more keys are derived from the seed, and then for each such child of the seed, one or more keys may be derived from that key, and so forth. In this tree structure each node is a key and each edge represents the derivation of that key from its parent. Given the parent key or seed it is possible for any party who knows the algorithm to deterministically determine its child or children, but given a child key it is not possible (or at least not computationally feasible) to determine the parent key. Various forms of CKD are known in the art which allow one to generate a hierarchical key set with any arbitrary graph structure (e.g. tree structure) that is desired.

Note: where it is said that a given key or a key graph structure is derived by applying a CKD to a seed or parent key, this does not exclude that the key or graph structure may be derived by applying the CKD to the seed/parent and some other data. For instance, in embodiments the CKD function takes as an input: a parent key or seed, some other data called a chain code, and an index for which the child (of multiple siblings) is being created for the given parent. Equivalently one could consider the chain code and/or indices as being parameters parameterizing the form of CKD.

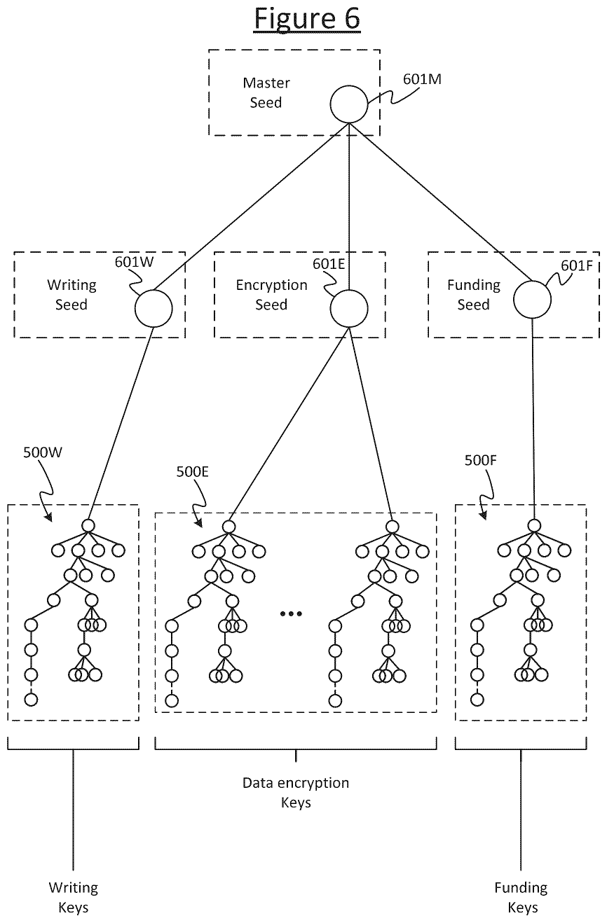

Note also that the term “seed” as used herein does not necessarily imply that the seed is the absolute highest level key in an overall hierarchy or tree. More generally, one can apply the CKD to any key in a hierarchy to generate one or more child keys from it. The “seed” herein is simply any parent key or value from which other child keys of a given key set are derived. In embodiment the seed may itself be a child key of another key or seed in a wider hierarchy (e.g. see FIG. 6, to be discussed in more detail later).

As discussed above, each Metanet node 301 has a key P associated with it at the Metanet network layer (see Pnode and Pparent in the example of FIG. 4). In some examples it would be advantageous to generate these keys according to a tree structure 500 that maps directly onto corresponding tree structure 300 of the Metanet network nodes 301 and edges 302. That is, each Metanet node 301 in the Metanet tree structure maps uniquely onto one corresponding key in the key tree 500, and each Metanet edge 302 maps uniquely onto one corresponding key derivation edge in the key tree 500. This will mean that given the position of a node 301 in the Metanet tree, and knowledge of a seed, and the form of CKD function used, it will always be possible to derive the relevant key required for that node 301.

### 6. Functional Key Domains

If we examine a typical Metanet transaction 152N such as shown in FIG. 4, which may contain encrypted data, and its corresponding funding transaction 152F, it can be seen that there are a number of different keys that are associated with a single Metanet node 301 (e.g. Pnode, Pparent, TxIDnode, ek).

There are potentially many different types of keys associated with a Metanet node and its corresponding funding transaction. For example these may be classified according to their functions as follows:
Structure (writing) keys-P_node, P_parent
Encryption keys-ek
Funding keys-P_Funding

It should be noted that in more complex examples of Metanet transactions, there may also be other key types relating to other functions used to create a Metanet node transaction 152N or and/or perform other functions in relation to a Metanet node 301. For instance, another type of key could be an application layer key that facilitates an application layer function, e.g. idempotency keys (to ensure that the data of the node 301 is not used more than once or counted twice for some application layer purpose). As another example, as an alternative or in addition to encryption, the data content could be subject to another form of obfuscation such as padding or re-ordering, which may require a corresponding obfuscation key to obfuscate and/or de-obfuscate.

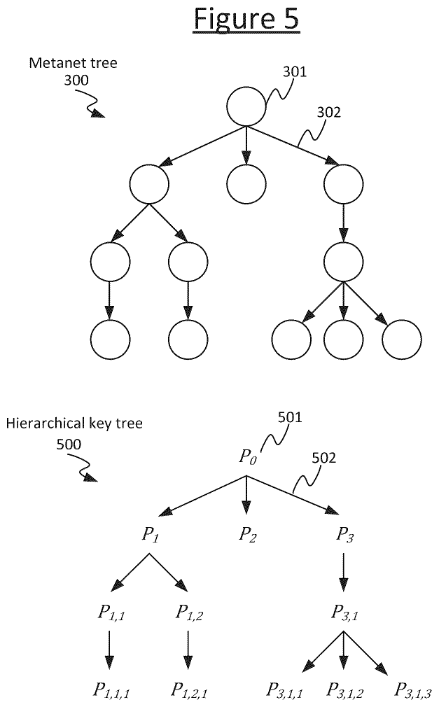

As discussed previously, it is advantageous to take advantage of the prevalence and robustness of the HD wallet standards (or the like) to manage keys, and in embodiments disclosed herein this desire extends to any or all such key types, e.g. structure keys, encryption keys, and funding keys. However, different key types may need to be handled and manage separately. Also, preferably all keys should stem from the same seed to reduce risk of compromise. These two requirements are, however, quite contradictory. It is not immediately clear how one should ensure the separation of keys while maintaining that all stem from the same seed key. To complicate things further, as discussed above, a further desirable property of such HD key hierarchies is that the derivation path for a given key should be mapped (at least in part) to a Metanet graph structure. In other words, the desire to reflect a Metanet graph structure in a key hierarchy (e.g. as in FIG. 5), acts as a third requirement that must be met, in addition to reconciling the first two conflicting requirements.

The following discloses a solution to this problem by defining functional key domains as branches of an HD wallet whose keys pertain to a single function involved in the creation of a particular transaction.

In the case of a Metanet transaction, where there may be two, three or more distinct functions to account for (e.g. structure, encryption, and funding), each key type will be assigned an independent branch of an HD key structure.

The writing keys (i.e. structure keys) Pnode, Pparent are used to sign Metanet transactions, the encryption keys are used to encrypt any content data included in the transactions, and the funding keys are used to sign the funding transactions whose UTXOs are consumed by the Metanet transactions.

All keys in the overall HD structure are unique, and cannot be related to one another without knowledge of the master key (mk) pair (master seed) for the wallet. However, they are related in that they all pertain to the same Metanet structure position. This common position is encoded using a system of multiple path types embedded within the overall path for a given key.

FIG. 6 illustrates an example of allocating different functional key domains. FIG. 6 illustrates an example derivation tree, which may be created using a CKD function. Preferably, at the top (source or root) of the tree is the master seed 601M (mk). Derived from this are a plurality of child seeds, one for each of the multiple types of function. Each child seed acts as the source/root of a respective set of keys for the respective type of function (e.g. writing, encryption and funding). In the example illustrated there are three child seeds for three such functions respectively: a writing seed 601W for deriving the set of writing keys P to enable writing the Metanet nodes 301, an encryption seed 601E for deriving the set of encryption keys ek for encrypting and/or decrypting the data content of the nodes 301, and a funding seed 601F for deriving the set of keys for funding the recordal of the corresponding transactions 152 of the nodes 301 on the blockchain 150. The seeds themselves may be thought of as a type of key (a sub-master key or seed of its respective key set in the case where all are derived from the same master key 601M).

Each set of keys comprises a respective tree structure according to which the keys in the respective key set are derived from one another. Each such tree-structure is a sub-tree of the overall tree stemming from the master seed 601M. Within each key set, the tree structure maps directly onto the tree structure of the Metanet 300. Thus the tree structures of the different key sets are the same as one another. So for example, there is one writing key per node 301 of the Metanet (or the fragment thereof in question), and the edges of derivation for those keys follow exactly the corresponding edges 302 in the Metanet tree structure 300. And at the same time, there is one funding key per node 301 of the Metanet (or the fragment thereof in question), and the edges of derivation for the funding keys follow exactly the corresponding edges 302 in the Metanet tree structure 300 and the ends between the corresponding writing keys in the writing key set. And similarly for encryption and/or any other function for which a key set is to be derived according to this scheme.

Note: a given key here may refer to a private key, or a public key, or a public-private key pair. In embodiments the private key is derived first according to the tree structure and then a corresponding public key is derived from the private key.

Note also that for one or more of the types of function, e.g. encryption, there may be multiple key sets generated, e.g. for multiple layers of encryption. In this case each of the encryption key sets has the same tree structure, as illustrated by way of example in the bottom-middle of FIG. 6.

Further, note again that the term “seed” as used herein does not necessarily imply the absolute ultimate master seed of the wider tree structure. For instance, the writing seed 601W is itself a child key of the master seed 601M. A seed is simply any type of key or value, which can be used to derive other keys. In embodiments the seeds of the different functions (e.g. 601W, 601E, 601F) are actually just keys all derived from some master seed or key 601M. A seed as referred to herein may refer to a special type of key that (at least locally) is the ‘top’ key of the hierarchy for a given set of keys, but may be a child in a wider hierarchy.

It will be appreciated that the examples of writing, encryption and funding are just some examples of the different types of function that may be implemented in the Metanet (or the like) for which respective key sets may be required, with a key per node within a given set for a given type of function. More generally, the scheme outlined above could be applied for the key sets of any first and second function, and in some embodiments a third function or more. For instance, encryption could be generalized to any obfuscation (e.g. padding or re-ordering). Or the scheme could be used for a completely different type of key, such as an application layer serial number to be assigned to each Metanet node 301 for some application layer purpose (e.g. idempotency).

### 7. Encrypting Data for Selective Disclosure

Embodiments of the present disclosure provide an encryption method (referred to herein as “wrapped encryption”) that can be used to selectively reveal (i.e. disclose) different data belonging to a dataset. For instance, data may be revealed depending on the sensitivity of the data, the type of data, the access rights of the data accessor, etc.

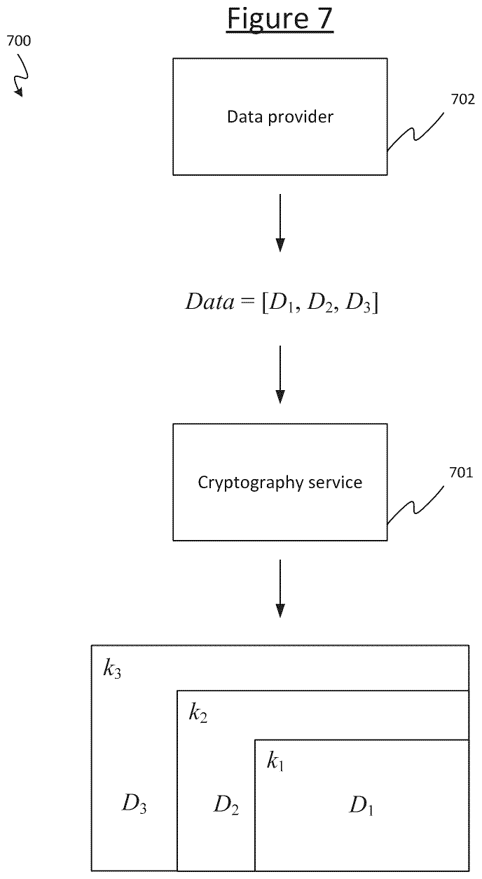

FIG. 7 illustrates an example system 700 for encrypting data using the method (i.e. protocol) disclosed herein. As shown, the system 700 includes a cryptography service 701 and a data provider 702. Whilst the cryptography service 701 and a data provider 702 are shown as sperate entities in FIG. 7, it is not excluded that the cryptography service 701 and a data provider 702 may be comprised by a common entity, e.g. the cryptography service 701 and a data provider 702 may be different components of the same system. Whilst now shown in FIG. 7, the system may also comprise a data accessor and one or more nodes 104 of a blockchain network 106. The data accessor may be the same entity as the data provider 702.

In general, the cryptography service 701 and data provider 702 each comprise and operate respective computer equipment comprising respective processing apparatus comprising one or more processors, e.g. one or more CPUs, GPUs, other accelerator processors, application specific processors, cryptoprocessors, and/or FPGAs. The respective computer equipment further comprises respective memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the respective computer equipment may store software comprising a respective instance of at least one client application arranged to run on the processing apparatus. It will be understood that any action attributed herein to the cryptography service 701 or the data provider 702 may be performed using the software run on the processing apparatus of the respective computer equipment of the cryptography service 701 or the data provider 702. The respective computer equipment comprises at least one user terminal, e.g. a desktop or laptop computer, a tablet, a smartphone, or a wearable device such as a smartwatch. The respective computer equipment may also comprise one or more other networked resources, such as cloud computing resources accessed via the user terminal.

In some examples, the cryptography service 701 may be configured to perform any of the actions attributed to Alice 103a and/or Bob 103b above as described with reference to FIGS. 1 and 2. Similarly, the data provider 702 may be configured to perform any of the actions attributed to Alice 103a and/or Bob 103b.

In general, the data provider 702 has access to a dataset that is to be encrypted. The dataset comprises a plurality of data items. The data items may relate to a person, company, organisation, object, etc. For instance, the data items may relate to personal details of a particular person such as the person's name, address, date of birth, email address occupation, hobbies, medical history, etc. The data items may relate to details of a company, e.g. financial records, employee records, purchase history, sales history, etc. In some examples, some data items may be more sensitive (or important) than others. As an example, a person's email address may be more sensitive than their hobbies, in the sense that that the email address may be used to identify the person, whereas their hobbies may not, in most cases. The sensitivity of data items will be discussed further below. In some examples, the data items may not relate to any particular entity.

In some examples, the data provider 702 sends the dataset to the cryptography service in plaintext. That is, the entire dataset is in plaintext and not encrypted. As will be discussed further below, in some examples the data provider 702 may encrypt one or more data items before sending the dataset to the cryptography service 701. In other words, in these examples the dataset obtained by the cryptography service 701 contains one or more data items that are encrypted, i.e. encrypted data items.

The data items in the set have an order, starting with a first data item and ending with a final data item. Depending on the number of data items in the dataset, one or more data items may be positioned between the first and final data items. It will be appreciated that “first” and “final” are merely used to refer to the end points of the dataset, and the first data item need not necessarily be positioned at the start of the dataset. In other words, the first data item may actually appear last in the dataset, with the final data item appearing first in the dataset. In this case, the second data item would be the data item that is positioned in the penultimate position in the ordered set of data items. The data items may be ordered by the cryptography service 701 or the data provider 702. For example, the cryptography service 701 may receive a set of data items and re-arrange (i.e. re-order) the data items such that the order of data items is scrambled (different) compared to the initial ordering of the received set. In some examples, the cryptography service 701 may generate one or more data items of the dataset.

Continuing with the example where the dataset is received in its raw form, the cryptography service 701 uses a wrapped encryption technique to encrypt the dataset. First, cryptography service 701 encrypts the first data item with a first encryption key. This generates a first encrypted value. As used herein, the term “value” may be replaced with “item” unless the context requires otherwise. That is to say, a value may not necessarily be a number. Then, the second data item is combined with (e.g. concatenated with) the first encrypted value to generate a first combined value. The cryptography service 701 encrypts the first combined value with a second encryption key to generate a second encrypted value. If the dataset contains only two data items, the process is complete. If the dataset contains one or more additional data items, the process continues. In this case, the third data item is combined with (e.g. concatenated with) the second encrypted value to generate a second combined value, and the second combined value is encrypted with a third encryption key to generate a third encrypted value. The process of encrypting data items continues until the final data item has been encrypted to generate a final encrypted value, also referred to as the encrypted payload. Each respective stage (or step) of encryption involves encrypting a single data item in its raw form. Other than the first encryption step, each encryption step also involves encrypting an encrypted value (which is combined with the plaintext data item).

As mentioned above, the data provider 702 may encrypt one or more of the data items. In these examples, the data provider 702 performs some of the encryption steps instead of the cryptography service 701. For example, the data provider 702 may encrypt the first data item, in which case the dataset provided to the cryptography service 701 contains the first encrypted value instead of the first data item. The data provider 702 may encrypt more than one data item. For example, the data provider 702 may generate the second encrypted value, in which case the dataset provided to the cryptography service 701 contains the second encrypted value instead of the first data item and the second data item. Put another way, the data provider 702 may use the wrapped encryption scheme to encrypt one or more data items, and send the resulting encrypted value (that encodes the one or more data items) to the cryptography service 701 instead of those data items. Effectively, in these examples one of the “data items” in the dataset received by the cryptography service 701 is an encrypted value encoding one or more of the original, plaintext data items.

In some examples, instead or in addition to the data provider 702 performing some of the steps of the encryption protocol and the cryptography service 701 then performing the remaining steps, the encryption protocol may be used to add additional layers of encryption to already encrypted data items. That is, the data provider 702 may encrypt one or more data items (using any encryption scheme), and provide the encrypted versions of the data items to the cryptography service 702, for the cryptography service 701 to then encrypt using the wrapped encryption protocol (which may use any encryption scheme, e.g. AES). Put another way, the data provider 702 provides a set of already-encrypted data items to the cryptography service 701, and then cryptography service 701 performs each step of the wrapped encryption protocol. In examples, each data item received by the cryptography service may already be encrypted by the data provider 702. In other examples, some but not all of the data items received by the cryptography service 701 may already be encrypted by the data provider 702.

Each respective encryption step involves a respective encryption key. In some examples, each encryption key is different. However, it is not excluded that one or more encryption keys may be the same. In some examples, one or more successive data items are encrypted using the same encryption key. This would allow those data items to be revealed using the same encryption key. For instance, those data items may be of similar sensitivity, importance, etc, and it may be appropriate/acceptable to reveal the subset of data items to the same data accessor.

The wrapped encryption process is illustrated in FIG. 7. In this example, the data provider 702 provides an array of data to the cryptography service 701. The data is encrypted element-wise by the cryptography service 701. In this example, data item D₁ is encrypted with encryption key k₁, the result of which is encrypted together with data item D₂ with encryption key k₂, and the result of which is encrypted together with data item D₃ with encryption key k₃. A new encryption key may be used for each of k₁, k₂ and k₃.

In some examples, the encryption keys may be used as part of a symmetric encryption scheme (e.g. AES) where the respective encryption key used to encrypt the respective data item is the same key needed to decrypt the corresponding encrypted value. As a particular example, the encryption algorithm may be 256-bit AES (CBC mode). In these examples, the respective encryption keys may be hashes of respective private keys. More on this is discussed below. Alternatively an asymmetric encryption scheme (e.g. ECIES) may be used, where a different key is required to decrypt the data. For example, the encryption keys may be private keys and the decryption keys may be the corresponding decryption keys.

The encryption keys may belong to, or be generated from (e.g. by hashing) keys belonging to a hierarchical key structure, e.g. similar to that described with reference to FIGS. 5 and 6. Each encryption key may be derived from a common key of the key structure. For example, each encryption may be (a hash of) a child private key of the same parent private key. This is illustrated schematically in FIG. 6, where multiple child encryption keys are derived from a parent key, which is ultimately derived from an encryption seed 601E.

In some embodiments, the cryptography service 701 generates a blockchain transaction which includes the encrypted payload, i.e. the final encrypted value. The cryptography service 701 sends the blockchain transaction to the blockchain network 106 to be stored on the blockchain 150. Additionally or alternatively, the cryptography service 701 sends the blockchain transaction to a different entity (e.g. the data provider 702) for sending to the blockchain network 106. This transaction may be labelled as a target data-storage transaction for ease of reference.

In these embodiments, the target data-storage transaction may be a data-storage transaction of an overlay network 300, e.g. the overlay network described with reference to FIGS. 3 to 6. That is, the target data-storage transaction may be a node of the overlay network 300. For example, the target data-storage transaction may be a Metanet transaction forming a node of the Metanet. The target data-storage transaction therefore includes a signature corresponding to the parent public key assigned to a parent node of the Metanet.

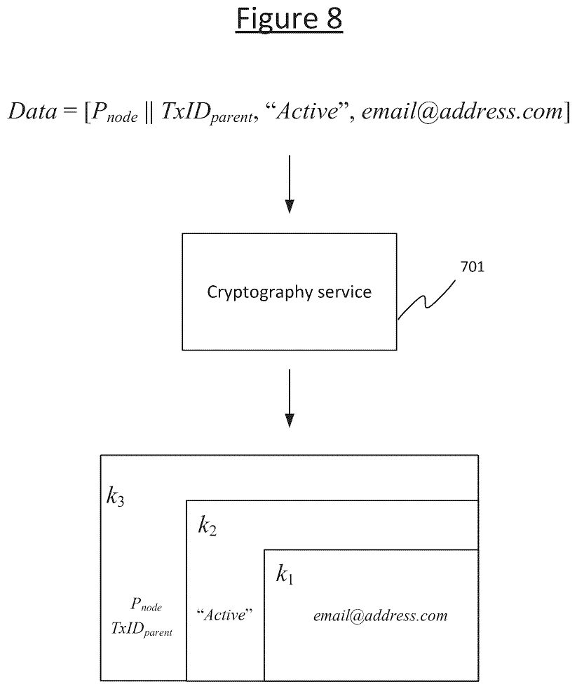

In some examples, the dataset may comprise one or more data items pertaining to the overlay network. For instance, one or more data items may relate to the graph structure of the overlay network. For example, one or more data items may contain a public key assigned to the node represented by the target data-storage transaction. The public key of the node uniquely identifies the target data-storage transaction as part of the graph structure. One or more data items may contain a transaction identifier of the parent transaction of the target data-storage transaction. The transaction identifier of the parent transaction signifies a link between the (child) target node corresponding to the (child) target data-storage transaction and the parent node corresponding parent data-storage transaction. FIG. 8 illustrates an example in which the final data item (appearing first in the data array) comprises a public key of the node P_{node} and a transaction identifier of the parent transaction TxIDₚₐᵣₑₙₜ. In this example, P_{node} and TxIDₚₐᵣₑₙₜ form a single data item.

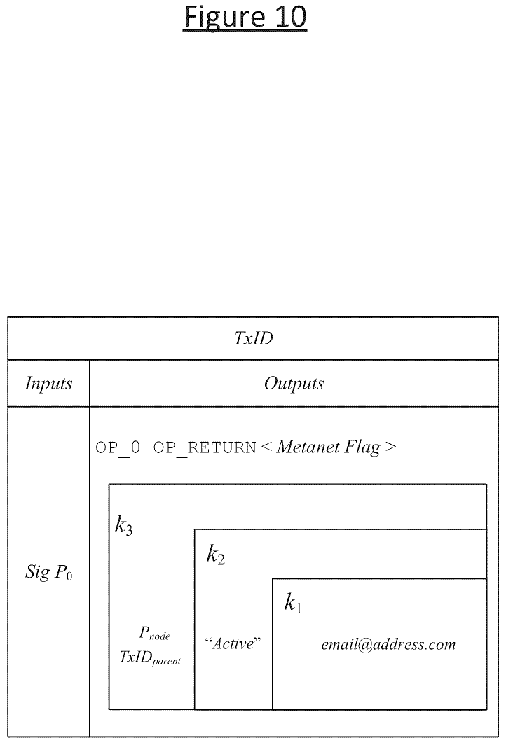

Previously, as discussed above with reference to FIG. 4, only the user data stored in a Metanet transaction was encrypted (not using the wrapped encryption scheme described herein). However, this meant that the structural information included in the Metanet transaction was immutably available on-chain and allowed the structure of Metanet trees to be identified. Even if the user data itself is not accessible due to said encryption, identifying and determining the structure of a Metanet tree can, in some examples, enable a third party to determine, or at least, infer properties of the user data. For example, if a third party knows that the Metanet nodes relate to a user's medical prescriptions, the third party can associate the frequency of Metanet transactions/nodes with the number of prescriptions, and thus infer the corresponding medicament or treatment. Now, by encrypting the structural information, even the structure of the Metanet tree to which the target data-storage node belongs cannot be determined. This improves the privacy of the underlying user data. In some examples, the target transaction includes a Metanet flag. However, this only allows a third party to determine that the transaction is a Metanet transaction. It does not allow the third party to determine the tree structure. FIG. 10 illustrates an example of a Metanet transaction comprising the encrypted payload. In this example, only the Metanet flag that identifies that the transaction is a Metanet transaction can be seen.

Using the wrapped encryption scheme to encrypt the structural information allows only the structural information to be revealed to a particular (i.e. given) data accessor, such that the Metanet tree structure can be determined (e.g. for auditing purposes) without revealing additional data, e.g. personal information pertaining to a user, company, etc.

Providing different sets of encryption keys to different entities effectively establishes different versions of the Metanet tree depending on which keys an entity has access to. For instance, providing only the encryption key that reveals the structural information allows an entity to only view the tree structure. I.e. the entity can see the number of nodes of the tree and the links between those nodes, but cannot see the data to which the tree relates. As another example, the cryptography service 701 may provide the entity with the encryption key that reveals the structural information, and the encryption key(s) that reveals one or more additional data items. This allows the entity to view those data items. In some examples, some but not all of the encryption keys are revealed. For example, the first data item may comprise identifying information, such as a name, email address, and so on. By not revealing the encryption key that encrypts the first data item, the entity can view all of the other information without determining who the information relates to. This may allow the third party to perform, for example, statistical analysis on the data without learning to the user's identity.

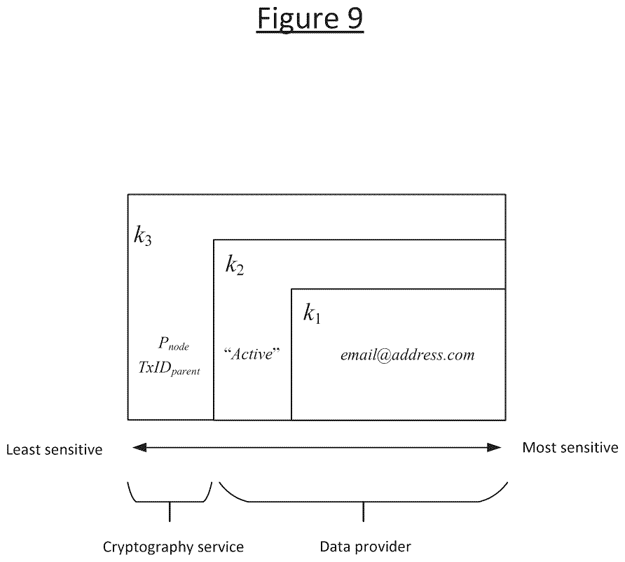

Sensitivity of data items was mentioned above. In some examples, different data items may have different levels of sensitivity, importance, secrecy, etc. In other words, the impact of certain data being revealed may differ between the data items. For example, a third party may gain less information by obtaining a user's post code compared to obtaining the user's first line of their address. Similarly, a third party may gain less information by obtaining a user's favourite sports team compared to obtaining the user's passport information. Therefore it may be important to apply more layers of encryption, and thus protection, to data items that are more sensitive, important, etc. This improves the privacy of those data items. In examples, the data items are ordered by level of sensitivity, with the most sensitive data item being encrypted with the most layers of encryption, and the least sensitive data item being encrypted with the least layers of encryption. FIG. 9 illustrates an example dataset in which a user's email address (most sensitive) is the first data item to be encrypted, and the structural information (least sensitive) is the last data item to be encrypted. In the example of FIG. 9, the first two data items are encrypted by the data provider 702 with the relevant encrypted value provided to the cryptography service 701. The cryptography service 701 then applies to the final layer of encryption by encrypting the third data item together with the received encrypted value.

### 7. Further Remarks

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In preferred embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In other embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

Some embodiments have been described in terms of the blockchain network implementing a proof-of-work consensus mechanism to secure the underlying blockchain. However proof-of-work is just one type of consensus mechanism and in general embodiments may use any type of suitable consensus mechanism such as, for example, proof-of-stake, delegated proof-of-stake, proof-of-capacity, or proof-of-elapsed time. As a particular example, proof-of-stake uses a randomized process to determine which blockchain node 104 is given the opportunity to produce the next block 151. The chosen node is often referred to as a validator. Blockchain nodes can lock up their tokens for a certain time in order to have the chance of becoming a validator. Generally, the node who locks the biggest stake for the longest period of time has the best chance of becoming the next validator.

For instance, in the above examples it has been described that the overlay-layer links are defined in the payloads of the Metanet transactions (e.g. by means of TxIDparent in the output of TxIDnode in the example of FIG. 4). However this is not essential. In alternative embodiments the graph structure need not actually be declared on-chain, or at least not entirely so. For instance, there may be provided a variant of Metanet where some data structure is stored on the blockchain but the overlay-layer links may be stored off-chain. The hierarchy of keys signing inputs of the data storage transactions would still be enough to recover (the majority of) the data structure, but only to somebody who knows the seed, i.e. not the general public viewing the blockchain, so this would improve privacy. In further variants, the graph structure of the Metanet (or other such overlay network) could be defined entirely off-chain, with only the data content stored on-chain.

Further, whilst the above has been described in terms of a tree structure, more generally the same principles can be applied to any graph structure. E.g. a given node 301 could have two parents. In this case the corresponding key would be derived from two parent keys.

It will be appreciated that the above embodiments have been described by way of example only. More generally there may be provided a method, apparatus or program in accordance with any one or more of the following Statements.

Statement 1. A computer-implemented method of encrypting data, wherein the method is performed by an encryption service and comprises:
generating an encrypted payload representing a dataset comprising an ordered set of data items starting with a first data item and ending with a final data item, wherein the encrypted payload is generated by performing the following steps:
a) encrypting the first data item with a first respective encryption key to generate a first encrypted value,
b) combining a second data item with the first encrypted value to generate a first combined value,
c) encrypting the first combined value with a second respective encryption key to generate a second encrypted value, and
d) repeating a process of i) combining a respective next data item with a respective latest encrypted value to generate a respective next combined value, and ii) encrypting the respective next combined value with a respective next encryption key to generate a respective next encrypted value, until a combination of the final data item and a respective latest encrypted value has been encrypted with a respective next encryption key to generate a final encrypted value, the encrypted payload comprising the final encrypted value.

Statement 2. The method of statement 1, wherein each respective encryption key is a different encryption key.

Statement 3. The method of statement 1, wherein one or more of the respective encryption keys are a same encryption key.

Statement 4. The method of any of statements 1 to 3, wherein said generating of the encrypted payload by the encryption service comprises performing each encryption step.

Statement 5. The method of any of statements 1 to 3, wherein said generating of the encrypted payload by the encryption service comprises performing at least one but not all encryption steps, wherein at least one encryption step is performed by a data provider, and wherein the method comprises:

receiving, from the data provider, the respective encrypted value generated as a result of the at least one encryption step performed by the data provider.

Statement 6. The method of statement 5, wherein the first data item is encrypted by the data provider, and wherein said receiving comprises receiving the first encrypted value.

Statement 7. The method of statement 5 or statement 6, wherein all but one of said encryption steps are performed by the data provider, and wherein the method comprises:
receiving, from the data provider, the respective encrypted value generated as a result of the all but one encryption steps performed by the data provider.

Statement 8. The method of any of statements 1 to 5, wherein one, some or all of the respective data items in the set of data items is a respective encrypted data item.

Statement 9. The method of any preceding statement, wherein each encryption step utilises a symmetric encryption scheme.

Statement 10. The method of any preceding statement, wherein each data item is associated with a respective sensitivity, and wherein the first data item is associated with a highest sensitivity.

Statement 11. The method of any preceding statement, wherein each respective encryption key is generated by hashing a respective private key.

Statement 12. The method of statement 11, comprising:
maintaining a hierarchical key structure comprising respective layers of private keys, each private key being derivable from a common seed value, and wherein each respective encryption key is a respective child private key of a same parent private key.

Statement 13. The method of any preceding statement, comprising:
storing the encrypted payload in a target data-storage transaction; and
causing the target transaction to be submitted to a blockchain network for storage on a blockchain.

Statement 14. The method of any preceding statement, wherein an overlay network is overlaid on data-storage transactions of the blockchain, whereby data content of the overlay network is stored in the data-storage transactions and overlay network links are defined between the data-storage transactions; wherein a graph structure of the overlay network comprises a plurality of nodes and edges between nodes, wherein each of the nodes corresponds to a different respective one of the data-storage transactions and each of the edges corresponds to a different respective one of the links, wherein each node is associated with a respective signing key for signing an input of a child data-storage transaction of the overlay network in order to authorize writing the child data-storage transaction to the blockchain, and wherein the target data-storage transaction is a respective child data-storage transaction of the graph structure.

Statement 15. The method of statement 14, wherein a respective data item of the dataset comprises structural information identifying the respective node corresponding to the target data-storage transaction in the graph structure.

Statement 16. The method of statement 15, wherein the structural information comprises a transaction identifier of a parent data-storage transaction of the target data-storage transaction and/or a public key assigned to the respective node corresponding to the target data-storage transaction.

Statement 17. The method of any preceding statement, comprising:
sending, to a data accessor, one or more of the respective encryption keys so as to selectively reveal one or more of the respective data items to the data accessor.

Statement 18. The method of statement 16 and statement 17, wherein the said one or more of the respective encryption keys comprises the respective encryption key used to encrypt the structural information.

Statement 19. The method of statement 17 or statement 18, wherein the data accessor is the data provider.

Statement 20. The method of any preceding statement, wherein each step of combining a respective data item with a respective encrypted value comprises concatenating the respective data item with the respective encrypted value.

Statement 21. Computer equipment comprising:
memory comprising one or more memory units; and
processing apparatus comprising one or more processing units, wherein the memory stores code arranged to run on the processing apparatus, the code being configured so as when on the processing apparatus to perform the method of any of statements 1 to 20.

Statement 22. A computer program embodied on computer-readable storage and configured so as, when run on one or more processors, to perform the method of any of statements 1 to 20.

According to another aspect disclosed herein, there may be provided a method comprising the actions of the encryption service and the data provider.

According to another aspect disclosed herein, there may be provided a system comprising the computer equipment of the encryption service and the data provider.

1. A computer-implemented method of encrypting data, wherein the method is performed by an encryption service and comprises:
generating an encrypted payload representing a dataset comprising an ordered set of data items starting with a first data item and ending with a final data item, wherein the encrypted payload is generated by performing the following steps:
a) encrypting the first data item with a first respective encryption key to generate a first encrypted value,
b) combining a second data item with the first encrypted value to generate a first combined value,
c) encrypting the first combined value with a second respective encryption key to generate a second encrypted value, and
d) repeating a process of i) combining a respective next data item with a respective latest encrypted value to generate a respective next combined value, and ii) encrypting the respective next combined value with a respective next encryption key to generate a respective next encrypted value, until a combination of the final data item and a respective latest encrypted value has been encrypted with a respective next encryption key to generate a final encrypted value, the encrypted payload comprising the final encrypted value.

2. The method of claim 1, wherein each respective encryption key is a different encryption key.

3. The method of claim 1, wherein one or more of the respective encryption keys are a same encryption key.

4. The method of claim 1, wherein said generating of the encrypted payload by the encryption service comprises performing each encryption step.

5. The method of claim 1, wherein said generating of the encrypted payload by the encryption service comprises performing at least one but not all encryption steps, wherein at least one encryption step is performed by a data provider, and wherein the method comprises:
receiving, from the data provider, the respective encrypted value generated as a result of the at least one encryption step performed by the data provider.

6. The method of claim 5, wherein the first data item is encrypted by the data provider, and wherein said receiving comprises receiving the first encrypted value.

7. The method of claim 5, wherein all but one of said encryption steps are performed by the data provider, and wherein the method comprises:
receiving, from the data provider, the respective encrypted value generated as a result of the all but one encryption steps performed by the data provider.

8. The method of claim 1, wherein one, some or all of the respective data items in the set of data items is a respective encrypted data item.

9. The method of claim 1, wherein each encryption step utilises a symmetric encryption scheme.

10. (canceled)

11. The method of claim 1, wherein each respective encryption key is generated by hashing a respective private key.

12. The method of claim 11, comprising:
maintaining a hierarchical key structure comprising respective layers of private keys, each private key being derivable from a common seed value, and wherein each respective encryption key is a respective child private key of a same parent private key.

13. The method of claim 1, comprising:
storing the encrypted payload in a target data-storage transaction; and
causing the target transaction to be submitted to a blockchain network for storage on a blockchain.

14. The method of claim 13, wherein an overlay network is overlaid on data-storage transactions of the blockchain, whereby data content of the overlay network is stored in the data-storage transactions and overlay network links are defined between the data-storage transactions; wherein a graph structure of the overlay network comprises a plurality of nodes and edges between nodes, wherein each of the nodes corresponds to a different respective one of the data-storage transactions and each of the edges corresponds to a different respective one of the links, wherein each node is associated with a respective signing key for signing an input of a child data-storage transaction of the overlay network in order to authorize writing the child data-storage transaction to the blockchain, and wherein the target data-storage transaction is a respective child data-storage transaction of the graph structure.

15. The method of claim 14, wherein a respective data item of the dataset comprises structural information identifying the respective node corresponding to the target data-storage transaction in the graph structure.

16. The method of claim 15, wherein the structural information comprises a transaction identifier of a parent data-storage transaction of the target data-storage transaction and/or a public key assigned to the respective node corresponding to the target data-storage transaction.

17. The method of claim 1, comprising:
sending, to a data accessor, one or more of the respective encryption keys so as to selectively reveal one or more of the respective data items to the data accessor.

18. The method of claim 16, comprising:
sending, to a data accessor, one or more of the respective encryption keys so as to selectively reveal one or more of the respective data items to the data accessor, wherein the said one or more of the respective encryption keys comprises the respective encryption key used to encrypt the structural information.

19. (canceled)

20. The method of claim 1, wherein each step of combining a respective data item with a respective encrypted value comprises concatenating the respective data item with the respective encrypted value.

21. Computer equipment comprising:
memory comprising one or more memory units; and
processing apparatus comprising one or more processing units, wherein the memory stores code arranged to run on the processing apparatus, the code being configured so as when run on the processing apparatus, the processing apparatus performs method of encrypting data, wherein the method is performed by an encryption service and comprises:
generating an encrypted payload representing a dataset comprising an ordered set of data items starting with a first data item and ending with a final data item, wherein the encrypted payload is generated by performing the following steps:
a) encrypting the first data item with a first respective encryption key to generate a first encrypted value,
b) combining a second data item with the first encrypted value to generate a first combined value,
c) encrypting the first combined value with a second respective encryption key to generate a second encrypted value, and
d) repeating a process of i) combining a respective next data item with a respective latest encrypted value to generate a respective next combined value, and ii) encrypting the respective next combined value with a respective next encryption key to generate a respective next encrypted value, until a combination of the final data item and a respective latest encrypted value has been encrypted with a respective next encryption key to generate a final encrypted value, the encrypted payload comprising the final encrypted value.

22. A non-transitory computer readable medium comprising a computer program and configured so as, when run on one or more processors, the one or more processors perform a method of encrypting data, wherein the method is performed by an encryption service and comprises:
generating an encrypted payload representing a dataset comprising an ordered set of data items starting with a first data item and ending with a final data item, wherein the encrypted payload is generated by performing the following steps:
a) encrypting the first data item with a first respective encryption key to generate a first encrypted value,
b) combining a second data item with the first encrypted value to generate a first combined value,
c) encrypting the first combined value with a second respective encryption key to generate a second encrypted value, and
d) repeating a process of i) combining a respective next data item with a respective latest encrypted value to generate a respective next combined value, and ii) encrypting the respective next combined value with a respective next encryption key to generate a respective next encrypted value, until a combination of the final data item and a respective latest encrypted value has been encrypted with a respective next encryption key to generate a final encrypted value, the encrypted payload comprising the final encrypted value.
